(19) United States
(12) Patent Application Publication
(10) Pub. No.: US 2022/0221118 A1
(43) Pub. Date: Jul. 14, 2022

(54) LAMPSHADE AND FLAMELESS CANDLE COMPRISING THE SAME

(71) Applicant: Nantong Ya Tai Candle Arts & Crafts Co., Ltd., Nantong (CN)

(72) Inventor: Yingqi DING, Nantong (CN)

(21) Appl. No.: 17/465,884

(22) Filed: Sep. 3, 2021

(30) Foreign Application Priority Data
Jan. 14, 2021 (CN) 202110048297.9

(51) Int. Cl. F21S 10/04; F21S 6/00; F21V 23/04; F21V 14/06

(52) U.S. Cl. CPC F21S 10/046; F21V 14/06; F21V 23/04; F21S 6/001

(57) ABSTRACT

A lampshade includes a head cover, a shell, and a swing assembly. The head cover is secured on the shell and the swing assembly is disposed in the shell.

### CROSS-REFERENCE TO RELATED APPLICATIONS

Pursuant to 35 U.S.C. § 119 and the Paris Convention Treaty, this application claims foreign priority to Chinese Patent Application No. 202110048297.9 filed Jan. 14, 2021, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to a lampshade and a flameless candle comprising the same.

Traditional flaming candles pose potential fire hazards. Flameless candles are currently available on the market and present in a variety of shapes to produce a realistic effect of flickering lights. The flameless candles include a flame sheet secured on a candle cap through an iron wire. The flame sheet can simulate the effect of free swing when the flame sheet is lighting, but swings at a small angle, which cannot produce a realistic effect of flickering lights. In addition, the swinging of the flame sheet creates a frictional resistance between the flame sheet and the iron wire. Each time a driving device drives the flame sheet, the flame sheet can only swing once or twice limited by the frictional resistance. Therefore, the driving device requires continuous energy to drive the flame sheet to swing, which is energy-consuming, thus shortening the battery lifespan of the flameless candles.

### SUMMARY

The disclosure provides a lampshade comprising a head cover, a shell, and a swing assembly; the head cover is secured on the shell and the swing assembly is disposed in the shell.

In a class of this embodiment, the head cover comprises a pedestal and a flame body disposed on the pedestal; and the head cover comprises a hollowed out bottom surface.

In a class of this embodiment, the shell comprises a hollow column; an inner wall of the hollow column comprises a vertical limit groove; and an outer wall of the hollow column comprises a vertical notch and a horizontal notch perpendicular to the vertical notch.

In a class of this embodiment, the swing assembly comprises a lamp bead device, a swing frame, and a circular base plate; the lamp bead device comprises a lamp bead and a support frame disposed aslant with respect to the swing frame; the support frame comprises a first rod and a second rod extending from a side edge of the first rod; the lamp bead is secured on the first rod and the second rod extends away from the lamp bead; the circular base plate comprises a U-shaped groove for accommodating an electromagnet; the lamp bead device is disposed on one side of the U-shaped groove; the swing frame is disposed vertically with respect to the pedestal; the swing frame comprises a through hole and the second rod is disposed through the through hole.

In a class of this embodiment, a part of the second rod abutting against an inner surface of the swing frame comprises a recess.

In a class of this embodiment, the swing frame comprises a top portion and a bottom portion; a convex lens is disposed on the top portion and is inclined toward the lamp bead; a pendulum is disposed on the bottom portion and comprises a magnet; the magnet and the electromagnet are disposed oppositely to each other.

In a class of this embodiment, the lamp bead is inclined at an angle of 20°-40°.

In a class of this embodiment, the lamp bead device and the swing assembly are separately disposed in the shell by a snap fit.

In another aspect, the disclosure also provides a flameless candle comprising the lampshade, a housing, and a base; the housing and the base are fixedly secured to the lampshade; the base comprises a battery housing and a control switch.

The following advantages are associated with the lampshade and the flameless candle of the disclosure:

1. The magnet and the electromagnet are disposed oppositely to each other, which makes the swing frame keep swinging, improving the realistic simulation effect of flickering flames; and

2. The part of the second rod abutting against the inner surface of the swing frame comprises a recess; the recess is configured to limit changes in position of the swing frame, so that the swing frame can stably swing on the second rod for a long time.

### BRIEF DESCRIPTION OF THE DRAWINGS

FIG. 1 is a perspective view of a lampshade according to one embodiment of the disclosure;

FIG. 2 is a side cross-sectional view of a lampshade according to one embodiment of the disclosure; and

FIG. 3 is a perspective view of a swing assembly according to one embodiment of the disclosure.

In the drawings, the following reference numbers are used: 1. Flame body; 2. Pedestal; 3. Shell; 4. Swing frame; 5. Circular base plate; 6. First rod; 7. Lamp bead; 8. Second rod; 9. Recess; 10. Convex lens; 11. Pendulum; 12. U-shaped groove; 31. vertical limit groove; 32. Vertical notch; 33. Horizontal notch.

### DETAILED DESCRIPTION

To further illustrate the disclosure, embodiments detailing a lampshade and a frameless candle comprising the same are described below. It should be noted that the following embodiments are intended to describe and not to limit the disclosure.

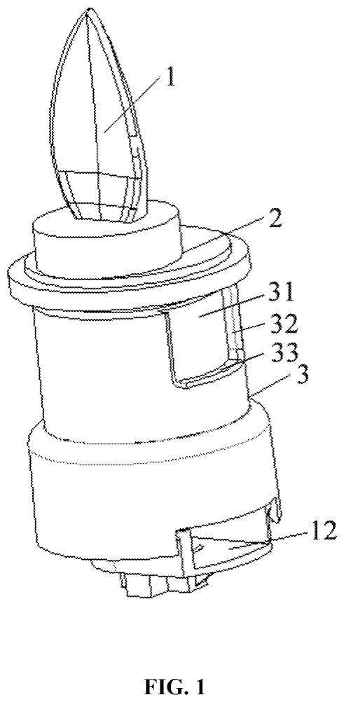

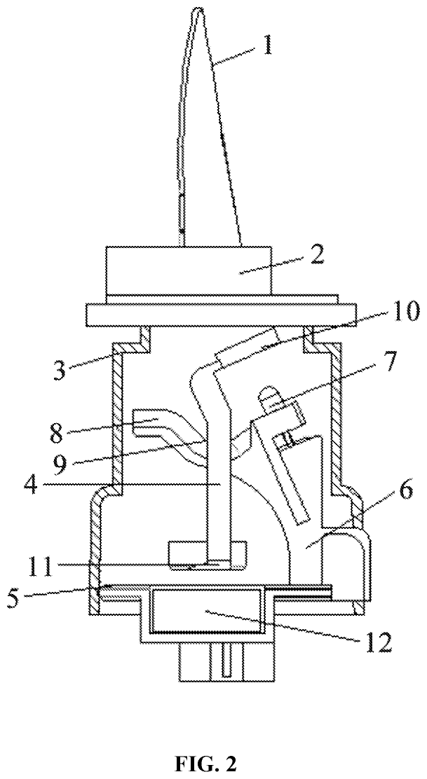

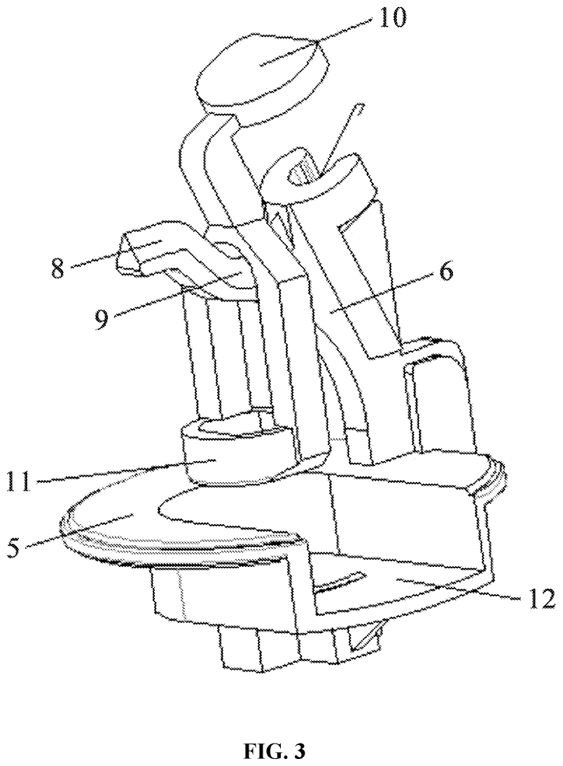

Referring to FIGS. 1-3, a lampshade comprises a head cover, a shell 3, and a swing assembly; the head cover is secured on the shell 3 and the swing assembly is disposed in the shell 3.

In certain embodiments, the head cover comprises a pedestal 2 and a flame body 1 disposed on the pedestal 2; and the head cover comprises a hollowed out bottom surface.

The flame body 1 comprises a first curved surface and a second curved surface. The first curved surface is aslant disposed on the pedestal 2 with respect to the second curved surface. The second curved surface is vertically disposed on the pedestal 2. The first curved surface and the second curved surface each comprise a top edge, two side edges, and a bottom edge; corresponding top edges and side edges are bonded to each other to form a first cavity; the bottom edge of the first curved surface and the connection line of two end points of the bottom edge of the first/second curved surface form a semicircular opening. The pedestal 2 comprises a first hollow column configured to accommodate a lamp bead of the flameless candle. The first hollow column comprises a first through hole corresponding to the semicircular opening in shape and size. The flame body 1 comprises the first curved surface and the second curved surface, and the lamp bead of the flameless candle is disposed in the first cavity formed by the first curved surface and the second curved surface, so that the light emitted from the lamp bead of the flameless candle irradiates the special-shaped head cover, and the emergent light scatters on the inner surface of the second curved surface, thereby producing a flame effect viewed from outside of the second curved surface. At the same time, the reflected lights generated on the inner surface of the second curved surface is converged on the inner surface of the first curved surface, thereby producing another flame effect viewed from outside of the first curved surface. The entire special-shaped head cover adopts a shape of a candle light, which can achieve a three-dimensional display of a realistic flame of a candle light.

In certain embodiments, the shell 3 comprises a second hollow column; the inner wall of the second hollow column comprises a vertical limit groove 31; and the outer wall of the second hollow column comprises a vertical notch 32 and a horizontal notch 33 perpendicular to the vertical notch.

In certain embodiment, the swing assembly comprises a lamp bead device, a swing frame 4, and a circular base plate 5. The lamp bead device comprises a lamp bead 7 and a support frame disposed aslant with respect to the swing frame 4. The support frame comprises a first rod 6 and a second rod 8 extending from a side edge of the first rod 6. The lamp bead 7 is secured on the first rod 6 and the second rod 8 extends away from the lamp bead 7. The circular base plate 5 comprises a U-shaped groove 12 and an electromagnet is disposed in the U-shaped groove 12. The lamp bead device is disposed on one side of the U-shaped groove 12. The second rod 8 is disposed through a through hole of the swing frame 4, so that the swing frame 4 is vertically hung on the second rod 8.

In certain embodiments, a part of the second rod 8 abutting against the inner surface of the swing frame 4 comprises a recess 9. The recess 9 is configured to limit changes in position of the swing frame 4, so that the swing frame 4 can swing stably on the second rod 8 for a long time.

In certain embodiments, the swing frame comprises a top portion and a bottom portion. A convex lens 10 is disposed on the top portion and is inclined toward the lamp bead 7. A pendulum 11 is disposed on the bottom portion and comprises a magnet. The magnet and the electromagnet are disposed oppositely to each other, so that the swing frame can keep swinging for a long time to produce a realistic effect of flickering lights.

In certain embodiments, the lamp bead 7 is inclined at an angle of 20°-40°.

In certain embodiments, the lamp bead device and the swing assembly are separately disposed in the shell by a snap fit.

In certain embodiments, a flameless candle comprises the lampshade, a housing, and a base. The housing and the base are fixedly secured to the lampshade. The base comprises a battery housing and a control switch.

The working principle of the flameless candle is detailed as follows: when in use, the control switch on the base of the bottom part of the housing is turned on, allowing the battery to provide steady DC power to the electromagnet. The electromagnet and the magnet are disposed oppositely to each other. When the flameless candle is energized, a repulsive magnetic field is generated, causing the swing frame 4 to swing back and forth on the U-shaped groove 12. When a power supply is turned on, the lamp bead 7 turns on and emits light. The light after passing through the convex lens 10 is known as swing light. The swing light with various brightness changes are irradiated on the head cover, to produce a realistic flickering effect of the flames.

In the flameless candle of the disclosure, the magnet and the electromagnet are disposed oppositely to each other, which makes the swing frame keep swinging, thus improving the realistic simulation effect of flickering flames and achieving a three-dimensional display of a realistic flame of a candle light. The part of the second rod abutting against the inner surface of the swing frame comprises a recess. The recess is configured to limit changes in position of the swing frame, so that the swing frame can stably swing on the second rod for a long time.

It will be obvious to those skilled in the art that changes and modifications may be made, and therefore, the aim in the appended claims is to cover all such changes and modifications.

What is claimed is:

1. A lampshade comprising a head cover, a shell, and a swing assembly; wherein the head cover is secured on the shell and the swing assembly is disposed in the shell.

2. The lampshade of claim 1, wherein the head cover comprises a pedestal and a flame body disposed on the pedestal; and the head cover comprises a hollowed out bottom surface.

3. The lampshade of claim 2, wherein the shell comprises a hollow column; an inner wall of the hollow column comprises a vertical limit groove; and an outer wall of the hollow column comprises a vertical notch and a horizontal notch perpendicular to the vertical notch.

4. The lampshade of claim 1, wherein the swing assembly comprises a lamp bead device, a swing frame, and a circular base plate; the lamp bead device comprises a lamp bead and a support frame disposed aslant with respect to the swing frame; the support frame comprises a first rod and a second rod extending from a side edge of the first rod; the lamp bead is secured on the first rod and the second rod extends away from the lamp bead; the circular base plate comprises a U-shaped groove for accommodating an electromagnet; the lamp bead device is disposed on one side of the U-shaped groove; the swing frame is disposed vertically with respect to the pedestal; the swing frame comprises a through hole and the second rod is disposed through the through hole.

5. The lampshade of claim 4, wherein a part of the second rod abutting against an inner surface of the swing frame comprises a recess.

6. The lampshade of claim 4, wherein the swing frame comprises a top portion and a bottom portion; a convex lens is disposed on the top portion and is inclined toward the lamp bead; a pendulum is disposed on the bottom portion and comprises a magnet; the magnet and the electromagnet are disposed oppositely to each other.

7. The lampshade of claim 4, wherein the lamp bead is inclined at an angle of 20°-40°.

8. The lampshade of claim 4, wherein the lamp bead device and the swing assembly are separately disposed in the shell by a snap fit.

9. A frameless candle, comprising the lampshade of claim 1, a housing, and a base; wherein the housing and the base are fixedly secured to the lampshade; the base comprises a battery housing and a control switch.
